(19) United States
(12) Patent Application Publication
(10) Pub. No.: US 2007/0218240 A1
(43) Pub. Date: Sep. 20, 2007

(54) Laser sculptured three-dimensional carbon fiber pattern sticker

(76) Inventor: Wei-Yin Chang, Taichung Hsien (TW)

Correspondence Address: BRUCE H. TROXELL;SUITE 1404, 5205 LEESBURG PIKE, FALLS CHURCH, VA, 22041, US

(21) Appl. No.: 11/377,349

(22) Filed: Mar. 17, 2006

(51) Int. Cl. B32B 1/04

(52) U.S. Cl. 428/76

(57) ABSTRACT

A laser sculptured three-dimensional carbon fiber pattern sticker that is versatile and fabricated at a lower cost to be bonded to the surface of an article mainly includes a base paper, a body and a release paper. The body consists of a thermoplastic resin layer, a laser sculptured three-dimensional carbon fiber pattern layer, a solvent-resistant protection layer and a peelable resin layer. The laser sculptured three-dimensional carbon fiber pattern layer is formed in a carbon fiber woven texture through a computer graphic process to be fabricated to a zinc (copper) plate that is printed onto the thermoplastic resin layer through an embossing machine under instantaneous heating. When in use, peel off the release paper, and soak the body, the base paper can be separated from the body, and the body can be heated or dried to make the thermoplastic layer bonding to the surface of the article.

### BACKGROUND OF THE INVENTION

1. Field of the Invention

The present invention relates to a laser sculptured three-dimensional carbon fiber pattern sticker and particularly to a laser sculptured three-dimensional carbon fiber pattern sticker that is versatile and costs less and can be bonded to the surface of articles.

2. Description of the Prior Art

A laser image pattern can generate different refraction according to different lights to create a strong visual and appealing effect. It is widely used on various types of goods. However the conventional laser image pattern can generate only a planar effect. It can be adopted on carbon fibers to produce various types of goods (such as carbon fiber tubes used on bicycles). Not much innovation has been made. If stickers with a three-dimensional carbon fiber textures are available, they can enhance the added value of goods. Aside from improving appealing, fabrication process and cost of products can be reduced and practicality can be enhanced. All this can help to expand the market.

### SUMMARY OF THE INVENTION

In view of the aforesaid problems occurred to bonding of the conventional laser image pattern and goods, the present invention aims to provide a laser sculptured three-dimensional carbon fiber pattern that has a greater applicability. The invention includes fabricating a zinc (copper) plate and bonding to a thermoplastic resin layer to form a sticker structure. Such a structure costs less and can be bonded to the surface of goods.

Therefore the primary object of the invention is to provide a laser sculptured three-dimensional carbon fiber pattern sticker that can be bonded to an article easily.

Another object of the invention is to provide a laser sculptured three-dimensional carbon fiber pattern sticker that can be produced at a simplified process and a lower cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of the invention.

FIG. 2 is a flow chart showing use procedures of the invention.

FIG. 3 is a schematic view of the invention bonding to an article.

FIG. 4 is a schematic view of another embodiment of the invention.

FIG. 5 is a schematic view of yet another embodiment of the invention.

Attachment 1: A prototype of the invention.

### DESCRIPTION OF THE PREFERRED EMBODIMENTS

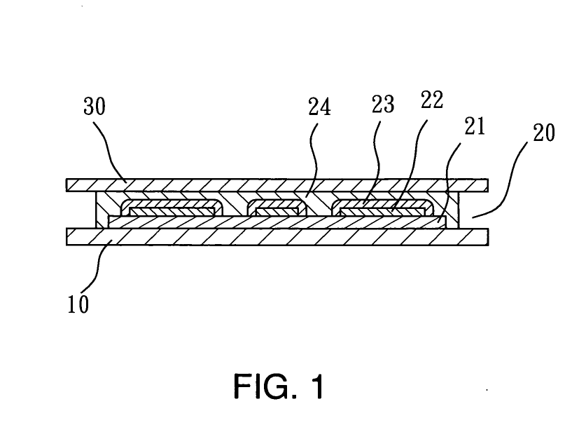

Referring to FIG. 1, the invention mainly includes a base paper 10, a body 20 and a release paper 30.

The body 20 includes:
a thermoplastic resin layer 21 located on the base paper 10 that can be heated or dried to be bonded to the surface of an article;
a laser sculptured three-dimensional carbon fiber pattern layer 22 formed in a carbon fiber woven texture through a computer graphic process to be fabricated to a zinc (copper) plate that has a three-dimensional layer in a concave and convex fashion. The three-dimensional carbon fiber pattern texture is printed onto the thermoplastic resin layer 21 through an embossing machine under instantaneous heating. The zinc (copper) plate may also be embossed on a plated silver paper in a vacuum condition under high temperature to form the carbon fiber pattern to generate the laser sculptured three-dimensional carbon fiber pattern in the concave and convex fashion to generate refraction effect. The pattern on the laser sculptured three-dimensional carbon fiber pattern layer 22 is a carbon fiber-like texture formed on the entire layer or a partial carbon fiber-like texture.
a solvent-resistant protection layer 23 located on the laser sculptured three-dimensional carbon fiber pattern layer 22 to protect the laser sculptured carbon fiber pattern; and
a peelable resin layer 24 covering the thermoplastic resin layer 21 and fully encasing the solvent-resistant protection layer 23, and is covered by the release paper 30 on the top.

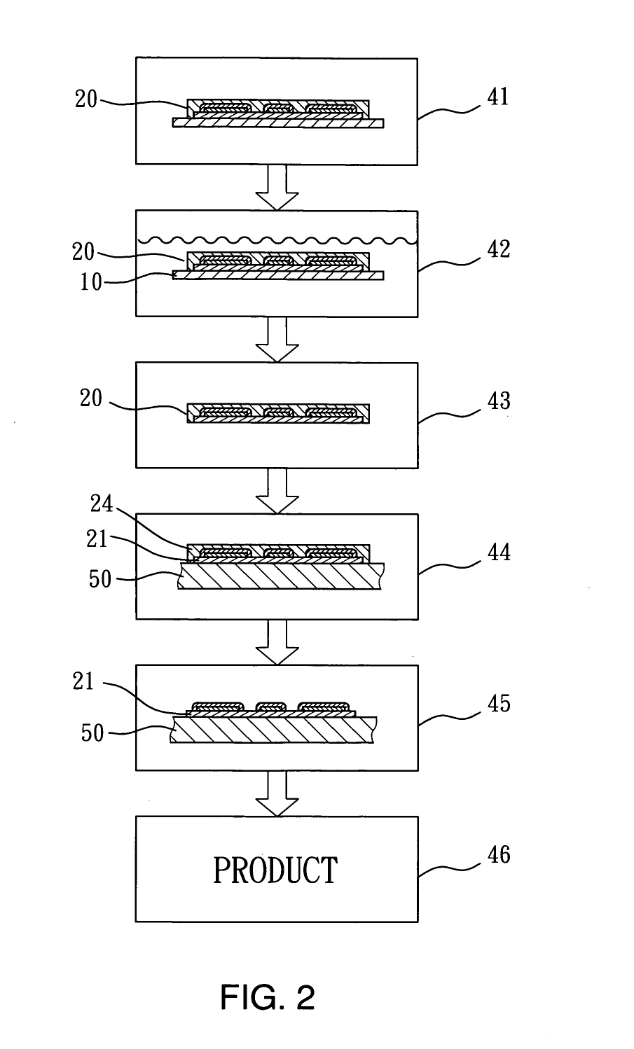

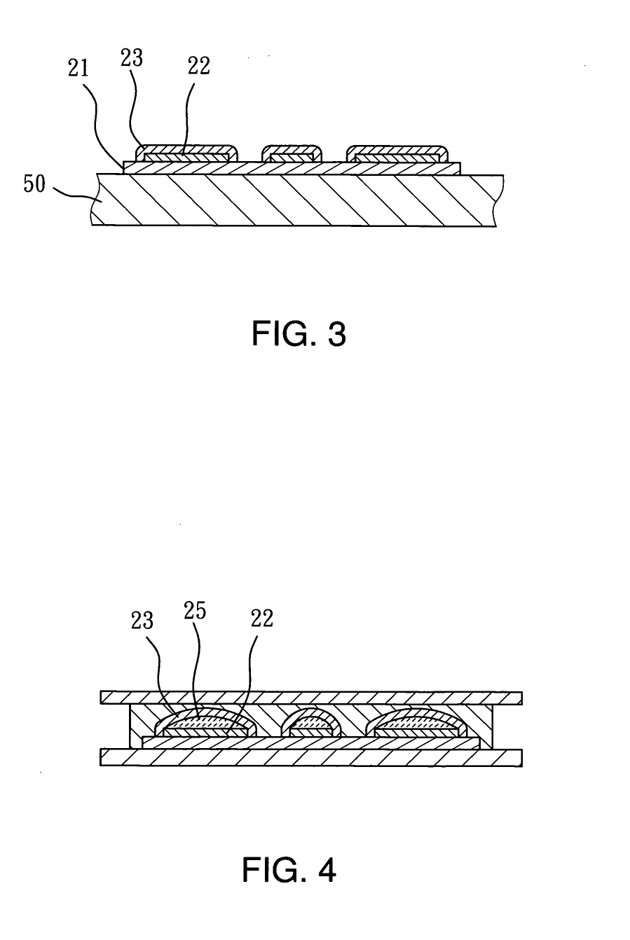

When in use, the following procedures are taken (referring to FIG. 2):
1. peeling 41: first, remove the release paper 30 from the body 20;
2. submerging 42: soak the body 20;
3. separating 43: separate the soaked body 20 and the base paper 10;
4. drying 44: heat the body 20 by heating, heat drying or natural drying so that the thermoplastic resin layer 21 is heated and bonds to the surface of an article 50;
5. peeling 45: remove the peelable resin layer 24; and
6. finishing 46: form the laser sculptured three-dimensional carbon fiber pattern on the article 50 (as shown in FIG. 3). Then coat a layer of PU or transparent lacquer, and dry to form the final finished product (refer to Attachment 1 for the prototype of the invention).

Refer to FIG. 4 for another embodiment of the invention. To make the laser sculptured three-dimensional carbon fiber pattern more versatile, a transparent ink layer 25 may be provided and interposed between the laser sculptured three-dimensional carbon fiber pattern layer 22 and the solvent-resistant protection layer 23. The transparent ink layer 25 is generally black and colored like carbon fibers, but may also be red, yellow or blue to offer more color selections.

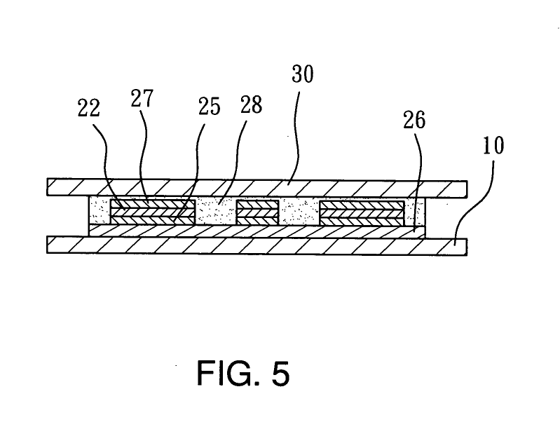

Refer to FIG. 5 for yet another embodiment of the invention. There is a resin layer 26 interposed between the base paper 10 and the transparent ink layer 25. The laser sculptured three-dimensional carbon fiber pattern layer 22 is located above the transparent ink layer 25, and a white ink 27 is disposed thereon as the base color. Then a glue layer 28 covers the resin layer 26, and fully covers the transparent ink layer 25, laser sculptured three-dimensional carbon fiber pattern layer 22 and while ink 27. A release paper 30 is laid on the top. The pattern and characters of the laser sculptured three-dimensional carbon fiber pattern layer 22 are in the opposite direction. The use procedures are same as shown in FIG. 2.

In summary, the invention bonds the sticker to various types of articles through a thermoplastic resin layer. It eliminates the complicated carbon fiber fabrication process of the conventional techniques. The fabrication process is simplified and the production cost is lower.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

I claim:

1. A laser sculptured three-dimensional carbon fiber pattern sticker comprising a base paper, a body and a release paper, wherein the body includes:
a thermoplastic resin layer located on the base paper;
a laser sculptured three-dimensional carbon fiber pattern layer formed in a carbon fiber woven-like texture through a computer graphic process to be fabricated to a zinc (copper) plate that has a three-dimensional pattern in a concave and convex fashion, the three-dimensional pattern with the carbon fiber woven-like texture being printed onto the thermoplastic resin layer through an embossing machine under high temperature;
a solvent-resistant protection layer located on the laser sculptured three-dimensional carbon fiber pattern layer to protect the laser sculptured three-dimensional carbon fiber pattern; and
a peelable resin layer covering the thermoplastic resin layer and fully encasing the solvent-resistant protection layer and being covered by a release paper on the top.

2. The laser sculptured three-dimensional carbon fiber pattern sticker of claim 1, wherein the thermoplastic resin layer is bonded to the surface of an article by heat through heating, heat drying or natural drying.

3. The laser sculptured three-dimensional carbon fiber pattern sticker of claim 1, wherein the laser sculptured three-dimensional carbon fiber pattern layer and the solvent-resistant protection layer are interposed by a transparent ink layer which is colored in red, yellow, black or blue.

4. The laser sculptured three-dimensional carbon fiber pattern sticker of claim 1, wherein the zinc plate is embossed on a plated silver paper in a vacuum condition under high temperature to form the carbon fiber pattern to fabricate a self-adhesive sticker.

5. The laser sculptured three-dimensional carbon fiber pattern sticker of claim 1, wherein the pattern or characters on the laser sculptured three-dimensional carbon fiber layer are stickers in an opposite direction.

6. The laser sculptured three-dimensional carbon fiber pattern sticker of claim 1, wherein the laser sculptured three-dimensional carbon fiber pattern layer is fabricated on a copper plate.

7. The laser sculptured three-dimensional carbon fiber pattern sticker of claim 1, wherein the pattern of the laser sculptured three-dimensional carbon fiber pattern layer is a carbon fiber-like texture formed on the entire layer.

8. The laser sculptured three-dimensional carbon fiber pattern sticker of claim 1, wherein the pattern and characters of the laser sculptured three-dimensional carbon fiber pattern layer are a partial carbon fiber-like texture.
